(19) United States
(12) Patent Application Publication
(10) Pub. No.: US 2013/0055091 A1
(43) Pub. Date: Feb. 28, 2013

(54) Graph-Based Virtual Data Center Requests

(71) Applicants: Debojyoti Dutta, Santa Clara, CA (US); Subrata Banerjee, Los Altos, CA (US); Ethan Spiegel, Mountain View, CA (US); Sumeet Singh, Saratoga, CA (US)

(72) Inventors: Debojyoti Dutta, Santa Clara, CA (US); Subrata Banerjee, Los Altos, CA (US); Ethan Spiegel, Mountain View, CA (US); Sumeet Singh, Saratoga, CA (US)

(73) Assignee: CISCO TECHNOLOGY, INC., San Jose, CA (US)

(21) Appl. No.: 13/215,662

(22) Filed: Aug. 23, 2011

(51) Int. Cl. G06F 15/16; G06F 3/01

(52) U.S. Cl. 715/736

(57) ABSTRACT

Graph-based virtual data center requests are described. In some implementations, a method includes displaying a graph having graphical elements representing network resources. A user can select one of the graphical elements and provide input specifying requirements for a network resource corresponding to the selected graphical element. A virtual data center request can be generated based on the graph and the specified requirements. The virtual data center request can be transmitted to a data center device for processing. In some implementations, the virtual data center request can be an extensible markup language (XML) representation of the graph that includes the specified service requirements. In some implementations, a data center server can receive a graph-based virtual data center request and allocate data center resources based on the virtual data center request.

### TECHNICAL FIELD

The present disclosure generally relates to cloud computing and infrastructure as a service.

### BACKGROUND

Traditionally, businesses that require computing resources have purchased hardware, software and manpower to provision and maintain in-house data centers. Some businesses have sought to avoid the cost and hassle of in-house data centers by outsourcing their computing needs to external service providers. Service providers offer infrastructure-as-a-service to customers through virtual data centers (VDCs) running on service provider data center (DC) equipment. Service providers provide the physical and virtual resources in service provider data centers to support a customer's needs through virtual data centers. The customer's computing needs are met by virtual data centers running on service provider data center equipment.

Customers can define virtual data center requirements, such as server types, bandwidth, etc., to support the customer's business needs. For example, VDCs can be defined and provisioned to support a customer's deployment of software, such as web-based applications and websites. The customer's needs are often expressed in broad, general terms without addressing specific network elements or specific service requirements in a network centric manner. For example, resource allocation solution concepts have only taken the virtual machines (VMs) into consideration. That is, they consider the underlying network topology to be an over-provisioned shared bus and, therefore, do not provide mechanisms for specifying requirements for the underlying network. However, to provide guaranteed resource allocation to customer's VDC requests, service provider data center resource allocation schemes should take bandwidth, quality of service and other network characteristics into account when allocating resources to virtual data center requests.

### BRIEF DESCRIPTION OF THE DRAWINGS

In the drawings:

FIG. 1 illustrates an example of a graph-based virtual data center request;

FIG. 2 illustrates an example process for generating a virtual data center request;

FIG. 3 illustrates an example of virtual data center resource allocation graphs;

FIG. 4 illustrates an example flow graph for determining data center resource allocations;

FIG. 5 illustrates an example process for allocating virtual data center resources; and

FIG. 6 illustrates an example of a computer system upon which an implementation can be implemented.

### DETAILED DESCRIPTION

Graph-based virtual data center requests are described. In the following description, for the purposes of explanation, numerous specific details are set forth in order to provide a thorough understanding of various implementations of graph-based virtual data center requests.

Implementations are described herein according to the following outline:
1.0 General Overview
2.0 Description of Particular Implementations
3.0 Graph-Based Virtual Data Center Requests
   3.1 Generating Requests
   3.2 Processing Requests
4.0 Implementation Mechanisms—Hardware Examples
5.0 Extensions and Alternatives

### 1.0 GENERAL OVERVIEW

Graph-based virtual data center requests are described. In some implementations, a method includes displaying a graph having graphical elements representing network resources. A user can select one of the graphical elements and provide input specifying requirements for a network resource corresponding to the selected graphical element. A virtual data center request can be generated based on the graph and the specified requirements. The virtual data center request can be transmitted to a data center device for processing. In some implementations, the virtual data center request can be an extensible markup language (XML) representation of the graph that includes the specified service requirements.

In some implementations, the network resource can be a network element (e.g., a router, switch, server, etc.). In some implementations, the network resource can be a connection between network elements. In some implementations, the requirements can include bandwidth requirements, throughput requirements, availability requirements, storage capacity requirements, redundancy requirements, load balancing requirements or any other requirement that might be imposed upon a computing device or network connection.

In some implementations, the method can include receiving input identifying a new network resource to add to the graph, adding a new graphical element representing the new network resource to the graph and receiving input specifying a service requirement for the new network resource.

In some implementations, the graphical elements can include a graphical element that represents a group of network resources. A user can select the graphical element associated with the group of network resources to display a sub-graph having graphical elements representing individual network resources in the group of network resources.

In some implementations, a method can include receiving at a virtual data center a request that specified requirements associated with network resources. The requirements can be compared to attributes of resources of the virtual data center and, based on the comparison, virtual data center resources can be identified that satisfy the requirements of the request. The identified resources can be allocated to satisfy the request. In some implementations, the virtual data center resources include virtual resources. In some implementations, the virtual data center resources include network elements. In some implementations, the virtual data center resources include connections between network elements. In some implementations, the resource attributes can include bandwidth, throughput, availability, storage capacity, redundancy requirements, load balancing or any other attribute that might be associated with a computing device or network connection.

Other implementations encompass a computer apparatus and a computer-readable medium configured to carry out the foregoing steps.

### 2.0 DESCRIPTION OF PARTICULAR IMPLEMENTATIONS

Resource Manager (RM) is a component of a cloud centric orchestration strategy. The RM can manage and allocate resources within the cloud. Within a cloud centric network (CCN), a CCN-specific resource manager (CCN-RM) can be employed to manage resources within the CCN. One key function of a CCN-RM is resource allocation. For example, the CCN-RM must determine whether a customer request for a virtual data center is a valid reservation, amidst data center (DC) constraints (e.g., bandwidth, storage capacity, redundancy, etc.).

A service provider (SP) data center can implement a virtual data center based on a customer's virtual data center request. For a service provider (SP) data center, there exist virtual machines within rack or blade servers connected to a top-of-the-rack switch (ToR or RS). These machines are aggregated using an aggregation switch. The real topology might be slightly different to support redundancy, throughput, load balancing, or other concerns. Thus, the real DC resources are connected using a virtual tree like topology (rather than fat trees or some interconnection network).

Customer Virtual Data Center (VDC) requests arrive in the form of resource requirements that need to be reserved and allocated. For example, the VDC request defines the requirements, parameters and/or constraints of the customer's VDC to be provisioned on the service provider's data center by a RM. The semantics of the resource reservation format is very important as it has ramifications in the algorithmic complexity of resource allocation. For example, if customers provide a topology of how virtual machines (VMs) and other elements are interconnected with networking elements, the complexity of the problem and the solution space changes significantly.

Requests for VDCs need to be reserved and/or allocated by the DC management and/or control plane (e.g., the CCN-RM). Thus, the CCN-RM should first determine the current (or the future) state of the CCN and then determine if it can reserve and allocate the resources, given the customer needs expressed in the VDC request and the constraints of the available resources in the CCN or service provider datacenter.

### 3.0 GRAPH-BASED VIRTUAL DATA CENTER REQUESTS

In some implementations, an annotated graphical representation of a virtual data center can be generated to describe the needs of a customer. For example, a graph having nodes and edges can represent a topology of virtual and/or physical resources and connections between resources of the customer's virtual data center. The graph can be annotated to indicate various requirements and/or constraints for each of the resources and connections (e.g., storage capacity, redundancy, throughput, quality of service requirements). A virtual data center request can be generated base on the virtual data center graph and transmitted to the service provider datacenter (e.g., the RM of the datacenter) for provisioning. The virtual data center request (e.g., the virtual data center graph) graph can be compared to the topology (physical and virtual) of a service provider's data center to determine how to allocate the resources of the service provider datacenter to meet the needs of the customer as expressed in the annotated graph in the virtual data center request.

3.1 Generating Requests

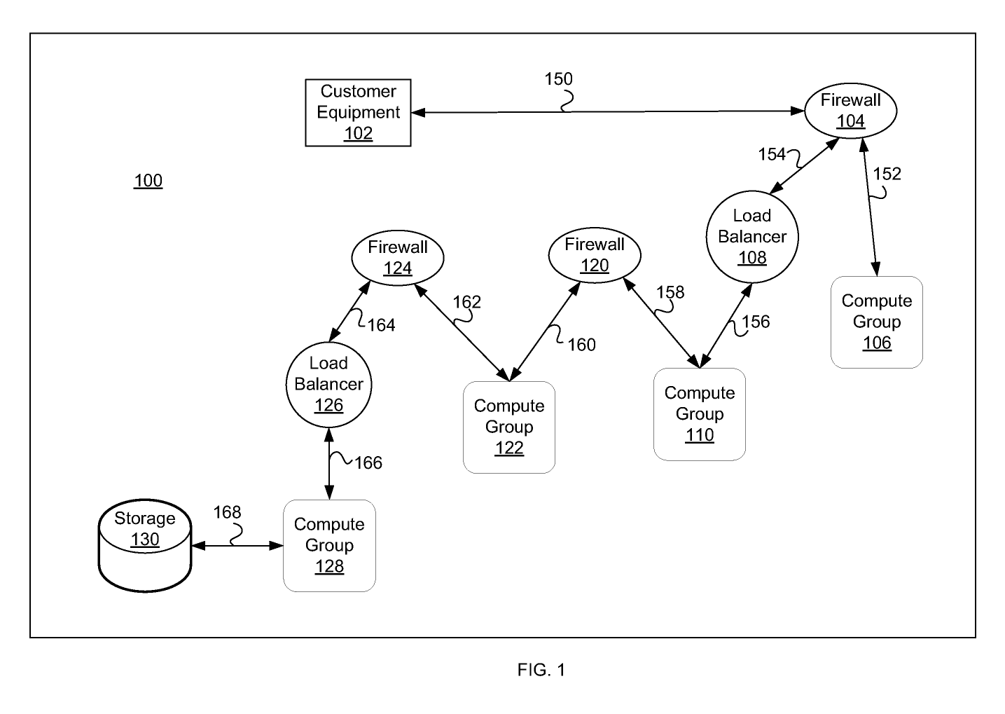

FIG. 1 illustrates an example of a graph-based virtual data center request. In some implementations, interface 100 can be presented to a customer-user so that the customer can create a graph representing requirements for a virtual data center. For example, interface 100 can be presented by a dedicated virtual data center client running on a customer's computer. Interface 100 can be an interface to a web-based client (e.g., a webpage or web application presented in a web browser window. The graph of interface 100 can represent a customer-specified virtual data center to be provisioned on a service provider's data center equipment.

In some implementations, the customer can interact with interface 100 to generate the graph (e.g., the graph of FIG. 1). In some implementations, the graph can represent a virtual and/or physical topology of network elements (e.g., physical devices, virtual machines, etc.) and connections between network elements that can be used to define the customer's virtual data center. For example, interface 100 can provide features that allow the customer to add graphical elements (e.g., elements 102-130 and 150-168) representing network elements (e.g., elements 102-130) and connections (e.g., 150-168) between network elements to the graph displayed on interface 100. For example, the interface 100 can provide menu items to add and remove network elements, specify types for the network elements, and specify interconnections between the network elements. The interface 100 can have a preconfigured collection of network elements that a customer can drag and drop onto the interface to generate the graph. For example, the interface 100 can allow the user to drag and drop a line representing a connection from one network element to another network element on the graph. In some implementations, the customer can build a new graph on an empty interface 100. For example, the customer can build a graph from scratch by adding graphical elements to interface 100. In some implementations, interface 100 can provide templates (e.g., predefined virtual data center graphs) that the customer can modify by adding and/or removing graphical elements to generate the customer's graph-based virtual data center request.

The example graph displayed on interface 100, is a graph representing network resources and connections for a virtual data center to support deployment of a three-tier application, including database server group 128, application server group 122 and web service group 110, as well as a generic compute group 106. For example each group 106, 110, 122 and 128 can represent multiple servers (virtual and/or physical). The virtual data center request graph indicates that all traffic to the virtual data center is protected by perimeter firewall 104. For example, traffic from customer premises equipment 102 along connection 150 can be monitored, filtered, analyzed by firewall 104. Additionally, traffic along connection 154 to web services machines in compute group 110 are to be load balanced amongst all the servers in the compute group by load balancer 108. The request graph also indicates that web servers 110 should communicate with a group of application servers 122, which will in turn communicate with dedicated database servers 128. Database servers 128 and application servers 110 are protected by firewall 120, 124 such that only authorized machines can get access to database servers 128 and application servers 110. Furthermore, requests from application servers 122 to database servers 128 are load balanced by load balancer 126. The network elements 104-130 and connections 150-168 can represent virtual or physical connections. For example, compute group 128 can be a group of virtual machines connected to a virtual firewall 124 along virtual connections 164 and 166. Compute group 110 can be connected to firewall 120 along a physical connection 158.

In some implementations, the graph represented by FIG. 1 can be a multi-level graph. In some implementations, a customer-user can select a compute group (e.g., compute group 122) to cause a sub-graph to be displayed corresponding to the compute group. For example, a user can select compute group 122 to display a sub-graph representing the servers (virtual and/or physical) within compute group 122 and the network elements and connections that are coupled to the servers within compute group 122. The sub-graph can display physical servers and software servers (e.g., services) provided by the selected compute group and the connections between the servers (e.g., physical, virtual, software), for example.

In some implementations, a customer-user can annotate graphical elements of the virtual data center graph to specify requirements for the network elements and/or connections corresponding to the annotated graphical elements. In some implementations, a customer-user can select a graphical element displayed on the graph of interface 100 and specify requirements for the network element or connection corresponding to the selected graphical element. For example, a customer-user can select a graphical element to cause a dialog box or other graphical input element to appear on interface 100. The customer user can provide input to the dialog box to specify requirements for the selected graphical element. If the customer's graph includes graphical elements 102, 104 and 150, the customer can select graphical element 150 and specify that the connection corresponding to graphical element 150 should support traffic at a rate of 2.5 Gigabits per second and should support virtual private network (VPN) service from the customer premises equipment 102 to the virtual data center through firewall 104. In some implementations, a customer can annotate any of the connections 150-168 to specify requirements (e.g., bandwidth requirements, QoS requirements, etc.) for the connections. Likewise, a customer can select graphical element 104 to specify requirements for the firewall corresponding to graphical element 104. For example, the customer can specify firewall rules to by applied by the firewall corresponding to graphical element 104.

By providing a graphical representation of the VDC request, visualization and modeling of the customer's request can be improved. The graph can make it easier for the customer to visualize and model the requirements (both physical and virtual) of the customer's virtual data center and provide a detailed network centric virtual data center request. This approach can allow the service provider to better serve the customer's virtual data center needs.

In some implementations, the VDC request can be presented to the provider data center resource manager as a XML document via XMPP-based transport channel. For example, the XML document can have two parts—one that describes the requested resource groups and another that specifies the connectivity requirements and services amongst these resource groups. An example XML document representing the customer's VDC request could be organized as follows:

<vdc-request>

<resource-groups>

<resource-group>

<id>FW01</id>
<name>Firewall 01</name>
<type>Firewall</type>
<network-segments>

<network>CPE-FW01</network>
<network>FW01-LB01</network>
<network>CG01-FW01</network>

</network-segments>
<network-policy>

<policy-type>firewall</policy-type>
<policy-name>FW01</policy-name>

</network-policy>

</resource-group>
<resource-group>

```
  <id>LB01</id>
  <name>Load Balancer 01</name>
  <type>loadbalancer</type>
  <network-segments>
```

```
  <network>FW01-LB01</network>
  <network>CG02-LB01</network>
```

```
  </network-segments>
  <network-policy>
```

```
  <policy-type>loadbalancer</policy-type>
  <policy-name>LB01</policy-name>
```

</network-policy>

</resource-group>
<resource-group>

<id>FW02</id>
<name>Firewall 02</name>
<type>Firewall</type>
<network-segments>

<network>CG02-FW02</network>
<network>CG03-FW02</network>

</network-segments>
<network-policy>

<policy-type>firewall</policy-type>
<policy-name>FW02</policy-name>

</network-policy>

</resource-group>
<resource-group>

<id>CG01</id>
<name>Compute Group 01</name>
<type>Compute-Group</type>
<network-segments>

<network>CG01-FW01</network>

</network-segments>

</resource-group>
<resource-group>

<id>CG02</id>
<name>Compute Group 02</name>
<type>Compute-Group</type>
<network-segments>

<network>CG02-FW01</network>
<network>CG02-LB01</network>

</network-segments>

</resource-group>

</resource-groups>
<network-segments>

<network>

<name>CG01-FW01</name>

<id>[id]</id>
<min-bandwidth-unit>Mbps</min-bandwidth-unit>
<min-bandwidth>500</min-bandwidth>
<avg-bandwidth-unit>Gbps</avg-bandwidth-unit>
<avg-bandwidth>1</avg-bandwidth>
<priority>normal</priority>

</network>
<network>

<name>FW01-LB01</name>
<id>[id]</id>
<min-bandwidth-unit>Gbps</min-bandwidth-unit>
<min-bandwidth>1</min-bandwidth>
<avg-bandwidth-unit>Gbps</avg-bandwidth-unit>
<avg-bandwidth>1.5</avg-bandwidth>
<priority>normal</priority>

</network>

</network-segments>
<network-policies>

<network-policy>”loadbalancer” name=”LB01”>

<loadbalancing-policy>round-robin</loadbalancing-policy>
<num-servers>40</num-servers>
<server-farm>CG01</server-farm>
<bandwidth-unit>Gbps</bandwidth-unit>
<bandwidth>1.5</bandwidth>

</network-policy>

</network-policies>

</vdc-request>

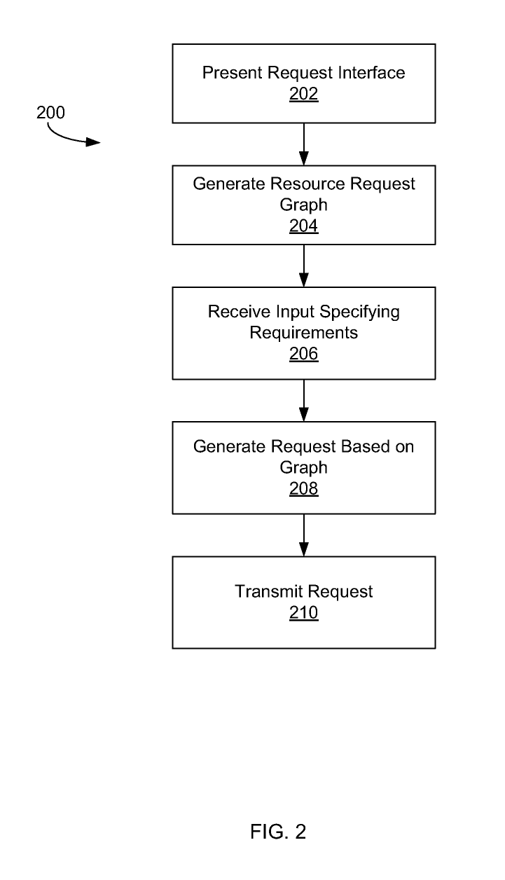

FIG. 2 illustrates an example process 200 for generating graph-based virtual data center requests. At step 202, the virtual data center request interface is presented to a customer-user. For example, the customer-user can invoke a dedicated VDC request client that is hosted on the customer-user's computer. The customer-user can invoke a web-based client (e.g., a browser) that can communicate with a web application for generating VDC requests and that is hosted by the service provider's data center. In some implementations, when the VDC request interface is invoked, a blank or empty interface is presented to the customer-user. For example, the blank interface does not display any nodes or edges representing a VDC topology. In some implementations, when the VDC request interface is displayed, a default VDC request template can be displayed. For example, a default VDC request template can include a predefined topology of network elements and connections between network elements.

At step 204, a virtual data center resource request graph is generated. For example, the customer user can interact with the VDC request interface to define the customer-user's VDC. If a blank interface is displayed, the customer-user can interact with the interface to add nodes and edges representing network elements and connections between network elements. If a default VDC request template is presented on the interface, the customer user can add or remove nodes and edges (network elements and connections) to the default template.

At step 206, input specifying requirements of the virtual data center is received. For example, the customer-user can select an element (e.g., node or edge) on the graph and provide input specifying requirements for the network element or connection corresponding to the graphical element. For example, upon selection of an element on the graph, an input interface (e.g., dialog box, input box, etc.) can be presented that allows the customer-user to specify requirements for the selected element. The user can provide input to the dialog box, for example, specifying requirements for the selected element. In some implementations, the requirements specified by the customer-user for an element can be displayed on user interface 100. For example, if a storage requirement is specified for a database element 130, the storage requirement can be presented on user interface 100 proximate to the database element 130.

At step 208, a virtual data center request is generated based on the graph generated at step 204 and the requirements specified at step 206. For example, an XML formatted request representing the VDC graph generated at step 204 and the requirements specified for the elements of the VDC graph specified at step 206 can be generated.

At step 210, the virtual data center request is transmitted to a service provider data center. For example, the XML formatted request can be transmitted to the data center for processing and allocation of the customer-user's virtual data center.

3.2 Processing Requests

In some implementations, a computing device at the service provider data center can receive and process the graph-based virtual data center requests described above. For example, the service provider's data center resource manager can receive a graph-based virtual data center request and process the request to allocate resources within the service provider's data center to service the customer's virtual data center needs as expressed in the request. In some implementations, the virtual data center request can be an XML document that represents the virtual data center graph generated using interface 100, as described above.

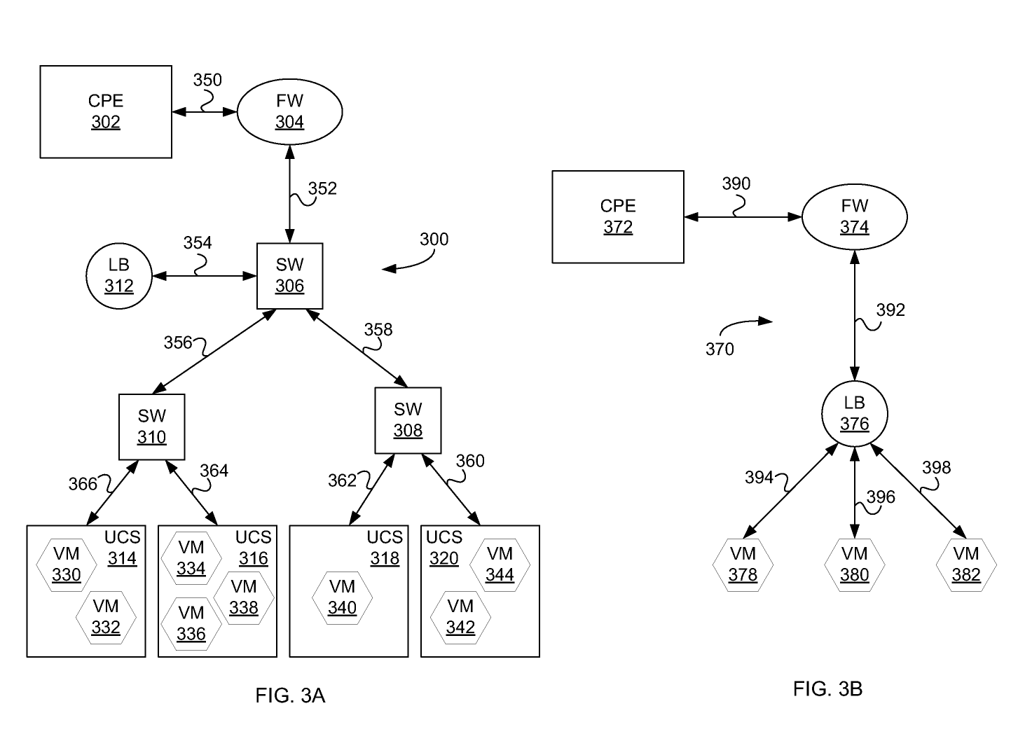

FIG. 3A illustrates an example service provider data center topology. For example, the topology of the service provider data center (or a portion of the data center) can be represented by graph 300. The nodes of graph 300 can correspond to data center resources such as firewall 304, switches 306-310, load balancer 312, and unified computing system (UCS) blades 314-320 with nodes that reflect virtual machines (VM) 330-344. The edges 350-366 (e.g., lines between nodes) represent network connectivity. In some implementations, edges 350-366 can be associated with multi-dimensional edge weights corresponding to commodities (e.g., bandwidth, delay, maximum jitter, buffer sizing, etc.) provided by the connections corresponding to the edges. For example, an edge can represent a connection between network resources (e.g., servers) and the edge weight can represent the bandwidth that can be supported by the connection. The edge weight can be used to specify the capacity of the connection between network resources when solving the maximum flow problem for resource allocation, as described below.

FIG. 3B illustrates an example virtual data center request graph 350. The VDC request is represented by request graph 350 which includes a line from the customer premises equipment node 372 followed by a tree like branching at the resource nodes. For example, graph 350 represents the VDC request with nodes representing virtual machines (VMs), virtual network elements and service elements, and the edges representing virtual network connectivity. In particular, graph 350 represents a customer-user VDC request defining a VDC with a firewall 374 followed by a load balancer 376 followed by a group of VMs 378, 380, 382. In this example, graph 350 corresponds to graphical elements 102, 104, 108 and 110 of FIG. 1. The edges of the graph (e.g., 390-398) can be associated with commodity requirements. For example, edges 390-398 can be associated with bandwidth requirements for the connections represented by the edges. These commodity requirements can be used as input to the maximum flow problem for resource allocation, as described below. For example, the commodity requirements can be used to determine the amount of flow that the data center represented by graph 300 should be able to handle. If the flow capacity of graph 300 is greater than or equal to the amount of flow indicated by the commodity requirements of associated with graph 350, then the data center represented by graph 300 has enough resources satisfy the VDC request represented by graph 350, as described in further detail below.

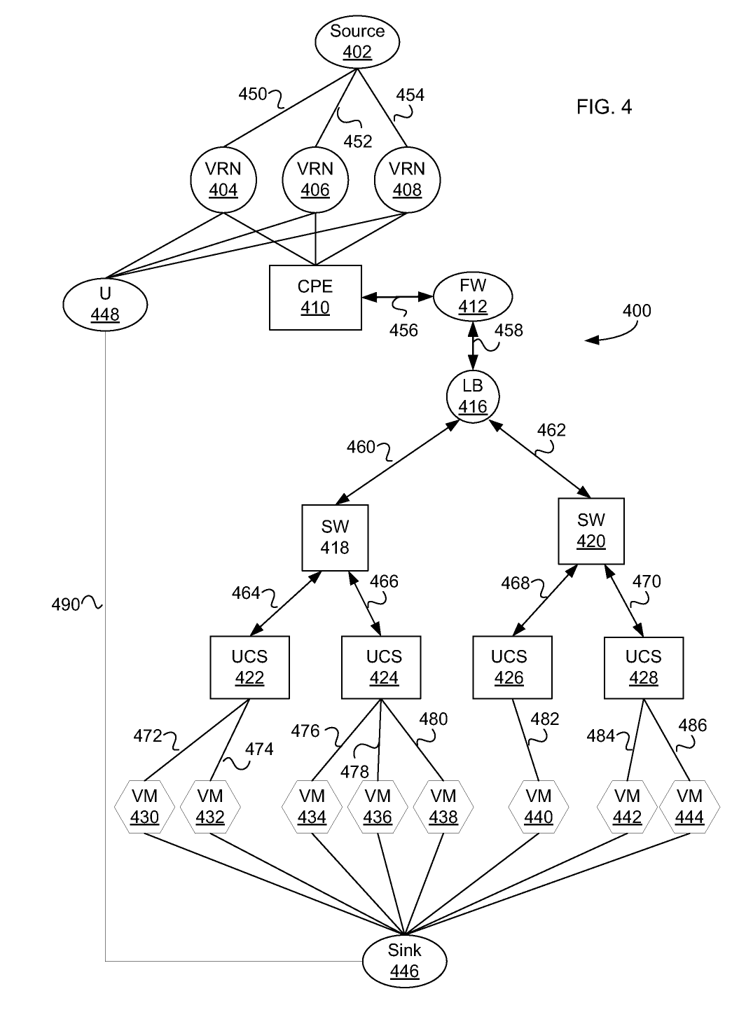

FIG. 4 illustrates an example flow graph 400 for determining data center resource allocations. For example, flow graph 400 can be constructed based on data center resource graph 300 and VDC request graph 350. Flow graph 400 can include nodes and edges from data center resource graph 300. For example, the using data center resource graph 300 as a starting point, virtual resource nodes 404-408 can be added to graph 400 to represent the virtual machine requirements specified in the VDC request and illustrated by VDC request graph 350. The virtual resource nodes 404-408 can be connected to source 402 (from which the flows flow). The amount of flow that flows from source node through virtual resource nodes 404-408 can correspond to the commodity requirements specified for the corresponding VMs 378-382 in graph 300. The virtual resource nodes 404-408 can be connected to an aggregation switch (not shown) that connects the virtual resource nodes 404-408 to a portion of the virtual data center from which data center resources will be selected to service the VDC request. For example, graph 300 can represent a portion of the virtual data center that has been selected to service the VDC request.

Flow graph 400 can include the nodes and edges of graph 300 and also edge weights (e.g., flow capacity) corresponding to commodities (e.g., bandwidth) associated with the edges. For example, nodes 410-444 can correspond to nodes 302-344 of FIG. 3 and edges 456-486 can correspond to edges 350-366 of FIG. 3. The commodity values associated with edges 456-486 (and edges 350-366 of FIG. 3) correspond to the amount of flow each edge can handle (e.g., the flow capacity of the edge). The virtual machine nodes 430-444 can be connected to sink 446 (into which the flow flows). The edges between virtual machine nodes and sink 446 have infinite capacity (e.g., can handle unlimited flow).

Flow graph 400 includes node 448 which is connected to virtual resource nodes 404-408 and through which unallocated flow passes. For example, if the amount of flow (as determined based on the commodity requirements specified in the VDC request, e.g., bandwidth) exceeds the capacity of the paths that run through nodes 410-444, the excess flow will be sent through the path that includes node 448. For example, if any amount of flow passes through node 448 it means that the data center represented by nodes 410-444 cannot handle the VDC request represented by graph 350. Node 448 is also connected to sink 448. The edges connected to node 448 have unlimited capacity and can handle unlimited flow.

To ensure that the paths through the data center nodes (e.g., nodes 410-444) are preferred over the paths through node 448 (which have unlimited capacity), each edge in graph 400 has an associated cost. For example, edges 456-458 can have a very low associated cost as compared to edge 490 thereby causing edges 456-458 to be preferentially selected over edge 490 when determining the optimal flow. Thus, the maximum flow problem for determining resource allocation described below can be a minimum-cost maximum-flow problem. In some implementations, node 448 will see flow only if there is not enough capacity along the paths that include nodes 410-444 to handle the total amount of flow from source 402 and virtual resource nodes 404-408.

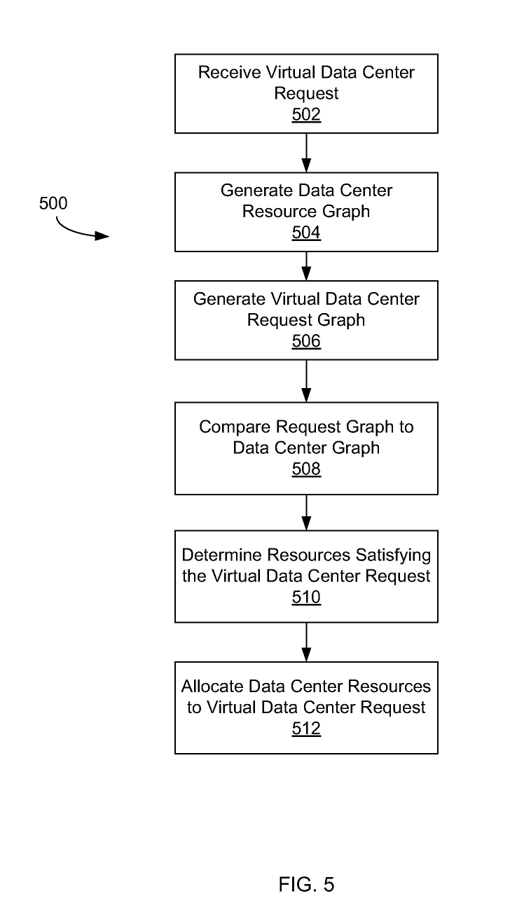

FIG. 5 illustrates an example process for allocating virtual data center resources by solving a maximum flow (or minimum-cost maximum-flow) problem based on graph 400 of FIG. 4. At step 502, a virtual data center request is received. For example, a virtual data center request can be received as an XML document that represents a VDC request graph and that includes requirements for each element (e.g., network element, connection) of the VDC. The VDC request can be formatted in any manner that can represent the tree-like structure of the VDC defined by the customer.

At step 504, a data center resource graph (e.g., graph 300) is generated. For example, resource graph 300 can be constructed to represent the resources (e.g., physical, virtual, network elements, connections, etc.) of the service provider data center. The resource graph 300 can be pruned based on policies or needs of the particular customer as specified in the VDC request. For example, the data center resource graph 300 can be programmatically represented by well-known computer language (e.g., C++, Java, etc.) tree structures.

At step 506, a virtual data center request graph is generated. For example, the VDC request graph 350 can be generated based on the virtual data center request received at step 502. When the request is received, the VDC request can be parsed and a computer language representation of the VDC request can be generated. For example, well-known C++ or Java computer language tree structures can be generated to represent the tree structure of the VDC specified by the request. Other computer programming languages can be used.

At step 508, the virtual data center request graph is compared to the data center resource graph. For example, VDC request graph 350 can be compared to data center resource graph 300 to determine resources of the data center that can meet the requirements of the customer-user as specified in the virtual data center request. In some implementations, the comparison of graph 300 to graph 350 can be performed by solving a flow optimization problem that includes graph 300 and graph 350. For example, the resource manager can identify resources to allocate from the data center to the virtual data center request by solving a maximum flow problem for a network flow (e.g., represented by graph 400) generated based on the nodes, edges and constraints (e.g., commodity requirements, available commodities) defined by graph 300 and graph 350.

In some implementations, graph 300 and graph 350 can be mapped into flow graph 400. The flow graph 400 can be used to solve the maximum-flow problem for allocating data center resources to VDC requests. For example, the constructed flow graph 400 represents a flow network with traffic coming in from the VRNs 404-408 and flowing into the VMNs 430-444. The required flow (e.g., the amount of flow that the data center is required to handle) is determined based on the commodity requirements specified in the VDC request. The flows take paths based on the available commodities (e.g., bandwidth) from the aggregation switch (not shown) to the top of the rack switches 418, 420 and into the VMs 430-444 inside the UCS blades 422-428. If there is a valid solution for the maximum flow problem, then the VMNs 430-444 that have positive flow through them correspond to the VMs 330-344 (FIG. 3) that should be chosen for allocation to the VDC request. If there is some flow via node 448, then the data center does not have adequate resources to satisfy the VDC request, as described above.

To ensure that the flows take paths through the data center nodes 410-444, each edge 450-490 is associated with a cost of choosing that edge and allocating a flow. Edge 490 between node 448 (U) and sink 446 (SiN) is associated with a very high cost (e.g., a cost greater than the sum of edges 456-486) so that the path through node 448 is only utilized if there is some constraint on capacity (e.g., there is not enough capacity through the data center nodes 410-444 to handle the required flow). Thus, the maximum-flow problem accounts for required flow, flow capacity and cost when determining an optimum flow through graph 400.

At step 510, data center resources that satisfy the virtual data center request are determined. For example, resources for satisfying the request can be determined by solving the maximum-flow (e.g., minimum-cost maximum-flow) problem for the integral flow case, as illustrated by the flow graph 400 of FIG. 4. For example, the maximum-flow (e.g., minimum-cost maximum-flow) problem can be solved using a variant of the well-known Ford-Fulkerson's algorithm. Other algorithms can be used for solving the maximum-flow problem for graph 400. For example, variations of the Edmonds-Karp algorithm or Dinitz blocking flow algorithms can be used. In some implementations, an integral version of the Ford-Fulkerson algorithm can be used to prevent splitting the bandwidth of 0.5 Gbps into 0.25 and 0.25 (this prevents selecting capacity constraint violating solutions to the maximum-flow problem). In some implementations, to solve the integral capacity problem, the bandwidths and the flows on the VRNs are normalized. For example, all of the bandwidths can be divided by 0.5 and converted to an integer value (e.g., round up or round down to nearest integer value). This will ensure that a flow solution will lead to a VM allocation that meets the requirements specified in the VDC request.

At step 512, data center resources can be allocated to the virtual data center request. In some implementations, the output of the maximum-flow problem can be used to determine which data center resources to allocate to a customer-user's VDC request. For example, once the maximum flow problem is solved for graph 400 and it is determined that none of the required flow was allocated to node 448, the virtual machine nodes (VMN) 430-444 that experienced positive flow can be identified. For example, VMNs 430, 436 and 440 can be associated with positive flow. In some implementations, the data center virtual machines that correspond to the VMNs that experienced positive flow can be allocated to the customer-user's VDC request. For example, the data center virtual machines (and the supporting UCS blades, switches, load balancers, firewalls and connection) that correspond to VMNs 430, 436 and 444 can be allocated to the VDC request.

### 4.0 IMPLEMENTATION MECHANISMS—HARDWARE EXAMPLES

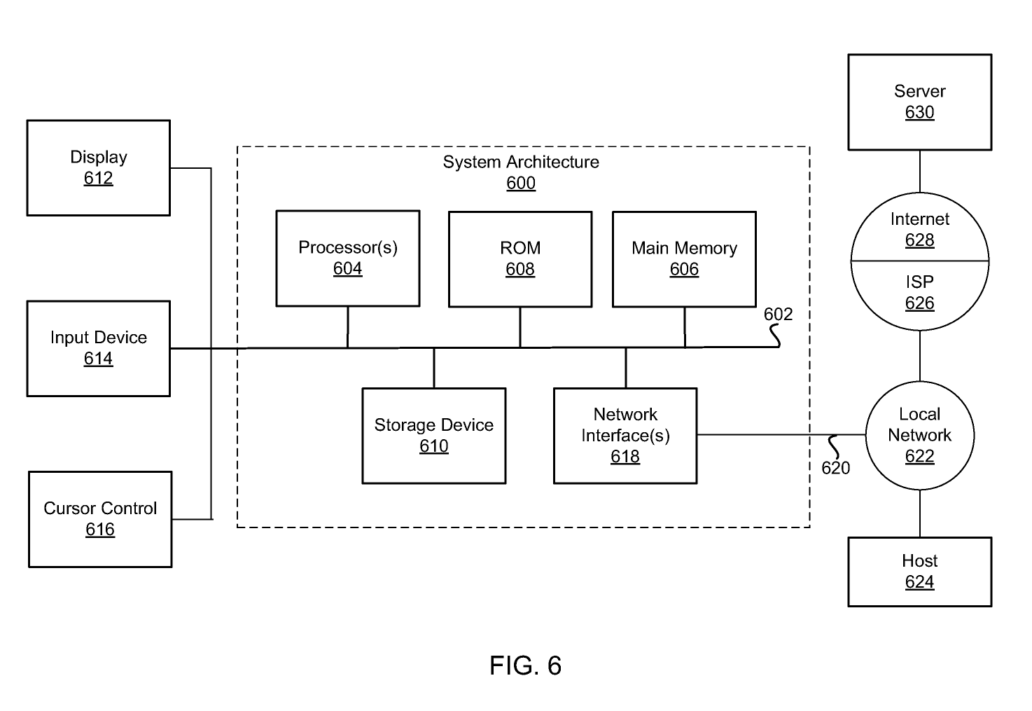

FIG. 6 is a block diagram that illustrates a computer system 600 upon which an implementation can be realized. Computer system 600 includes a bus 602 or other communication mechanism for communicating information, and a processor 604 coupled with bus 602 for processing information. Computer system 600 also includes a main memory 606 (e.g., a random access memory (RAM) or other dynamic storage device) coupled to bus 602 for storing information and instructions to be executed by processor 604. Main memory 606 also can be used for storing temporary variables or other intermediate information during execution of instructions to be executed by processor 604. Computer system 600 further includes a read only memory (ROM) 608 or other static storage device coupled to bus 602 for storing static information and instructions for processor 604. A storage device 610 (e.g., a magnetic disk or optical disk) is provided and coupled to bus 602 for storing information and instructions.

Computer system 600 can be coupled via bus 602 to a display 612 (e.g., a liquid crystal display (LCD), a cathode ray tube (CRT), etc.) for displaying information to a computer user. An input device 614, including alphanumeric and other keys, is coupled to bus 602 for communicating information and command selections to processor 604. Another type of user input device is cursor control 616 (e.g., a mouse, a trackball) or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Some implementations include the use of computer system 600 for performing techniques described herein. According to one implementation, the techniques described herein are performed by computer system 600 in response to processor 604 executing one or more sequences of one or more instructions contained in main memory 606. Such instructions can be read into main memory 606 from another machine-readable medium (e.g., storage device 610). Execution of the sequences of instructions contained in main memory 606 causes processor 604 to perform the process steps described herein. In alternative implementations, hard-wired circuitry can be used in place of or in combination with software instructions. Thus, implementations are not limited to any specific combination of hardware circuitry and software.

The term “machine-readable medium” as used herein refers to any medium that participates in providing data that causes a machine to operation in a specific fashion. In an implementation including computer system 600, various machine-readable media are involved, for example, in providing instructions to processor 604 for execution. Such a medium can take many forms, including but not limited to storage media and transmission media. Storage media includes both non-volatile media and volatile media. Non-volatile media includes, for example, optical or magnetic disks (e.g., storage device 610). Volatile media includes dynamic memory (e.g., main memory 606). Transmission media includes coaxial cables, copper wire and fiber optics, including the wires that comprise bus 602. Transmission media can also take the form of acoustic or light waves (e.g., those generated during radio-wave and infra-red data communications). Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media can be involved in carrying one or more sequences of one or more instructions to processor 604 for execution. For example, the instructions can initially be carried on a magnetic disk of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 can optionally be stored on storage device 610 either before or after execution by processor 604.

Computer system 600 can also include a network interface 618 coupled to bus 602. Network interface 618 provides a two-way data communication coupling to a network link 620 that is connected to a local network 622. For example, network interface 618 can be an integrated services digital network (ISDN) card or a modem to provide a data communication connection to a corresponding type of telephone line. As another example, network interface 618 can be a local area network (LAN) card to provide a data communication connection to a compatible LAN. Wireless links can also be implemented. In any such implementation, network interface 618 sends and receives electrical, electromagnetic or optical signals that carry digital data streams representing various types of information.

Network link 620 typically provides data communication through one or more networks to other data devices. For example, network link 620 can provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through network interface 618, which carry the digital data to and from computer system 600, are exemplary forms of carrier waves transporting the information.

Computer system 600 can send messages and receive data, including program code, through the network(s), network link 620 and network interface 618. In the Internet example, a server 630 might transmit a requested code for an application program through Internet 628, ISP 626, local network 622 and network interface 618. The received code can be executed by processor 604 as it is received, and/or stored in storage device 610, or other non-volatile storage for later execution.

### 5.0 EXTENSIONS AND ALTERNATIVES

In the foregoing specification, implementations have been described with reference to numerous specific details that can vary from implementation to implementation. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising:
displaying a graph having graphical elements representing network resources;
receiving a selection of one of the graphical elements;
receiving input specifying one or more requirements for a network resource corresponding to the selected graphical element;
generating a virtual data center request based on the graph and the one or more requirements; and
transmitting the virtual data center request to a virtual data center,
wherein the method is performed by one or more processors.

2. The method of claim 1, wherein the network resource is a network element.

3. The method of claim 1, wherein the network resource is a connection between network elements.

4. The method of claim 1, further comprising:
receiving input identifying a new network resource to add to the graph;
adding a new graphical element representing the new network resource to the graph; and
receiving input specifying a service requirement for the new network resource.

5. The method of claim 1, wherein the virtual data center request is an XML representation of the graph that includes the specified service requirement.

6. The method of claim 1, wherein the graphical elements include at least one graphical element that represents a group of network resources.

7. The method of claim 6, further comprising:
receiving a selection of the at least one graphical element; and
responsive to the selection, displaying a sub-graph having graphical elements representing individual network resources in the group of network resources.

8. A method comprising:
receiving, at a data center, a request that defines a virtual data center, the request defining requirements for the virtual data center;
comparing the requirements for the virtual data center to attributes of the data center;
based on the comparing, identifying resources of the data center that satisfy the requirements for the virtual data center; and
allocating the identified data center resources to the virtual data center.

9. The method of claim 8, wherein comparing the requirements for the virtual data center to the attributes of the data center comprises:
solving a maximum flow problem based on the requirements of the virtual data center and the attributes of the data center.

10. The method of claim 9, wherein solving the maximum flow problem comprises:
generating a graph based on the virtual data center and at least a portion of the data center; and
solving the maximum flow problem based on the graph.

11. A non-transitory computer-readable medium including one or more sequences of instructions which, when executed by one or more processors, causes:
displaying a graph having graphical elements representing network resources;
receiving a selection of one of the graphical elements;
receiving input specifying one or more requirements for a network resource corresponding to the selected graphical element;
generating a virtual data center request based on the graph and the one or more requirements; and
transmitting the virtual data center request to a virtual data center.

12. The non-transitory computer-readable medium of claim 11, wherein the network resource is a network element.

13. The non-transitory computer-readable medium of claim 11, wherein the network resource is a connection between network elements.

14. The non-transitory computer-readable medium of claim 11, wherein the instructions cause:
receiving input identifying a new network resource to add to the graph;
adding a new graphical element representing the new network resource to the graph; and
receiving input specifying a service requirement for the new network resource.

15. The non-transitory computer-readable medium of claim 11, wherein the virtual data center request is an XML representation of the graph that includes the specified service requirement.

16. The non-transitory computer-readable medium of claim 11, wherein the graphical elements include at least one graphical element that represents a group of network resources.

17. The non-transitory computer-readable medium of claim 16, wherein the instructions cause:
receiving a selection of the at least one graphical element; and
responsive to the selection, displaying a sub-graph having graphical elements representing individual network resources in the group of network resources.

18. A non-transitory computer-readable medium including one or more sequences of instructions which, when executed by one or more processors, causes:
receiving, at a data center, a request that defines a virtual data center, the request defining requirements for the virtual data center;
comparing the requirements for the virtual data center to attributes of the data center;
based on the comparing, identifying resources of the data center that satisfy the requirements for the virtual data center; and
allocating the identified data center resources to the virtual data center.

19. The non-transitory computer-readable medium of claim 18, wherein the instructions that cause comparing the requirements for the virtual data center to the attributes of the data center comprise instructions that cause:
solving a maximum flow problem based on the requirements of the virtual data center and the attributes of the data center.

20. The non-transitory computer-readable medium of claim 19, wherein the instructions that cause solving the maximum flow problem comprise instructions that cause:
generating a graph based on the virtual data center and at least a portion of the data center; and
solving the maximum flow problem based on the graph.
